(19) United States
(12) Patent Application Publication
(10) Pub. No.: US 2022/0176633 A1
(43) Pub. Date: Jun. 9, 2022

(54) ACCESSORY DEVICE FOR A SOLID-STATE ADDITIVE MANUFACTURING SYSTEM ENABLING PRINTING OF LARGE AND COMPLEX PARTS

(71) Applicant: MELD MANUFACTURING CORPORATION, Christiansburg, VA (US)

(72) Inventors: Nanci Hardwick, Christiansburg, VA (US); Chase Cox, Roanoke, VA (US); Christopher Garguilo, Christiansburg, VA (US); Joseph Lettery, Radford, VA (US); Frederic Lalande, Blacksburg, VA (US)

(21) Appl. No.: 17/395,891

(22) Filed: Aug. 6, 2021

Related U.S. Application Data
(60) Provisional application No. 63/062,266, filed on Aug. 6, 2020.

(51) Int. Cl. B29C 64/379; B33Y 30/00; B33Y 40/00; B33Y 50/00; B29C 64/386; B29C 64/295; B28B 1/00; B22F 10/80; B22F 12/90; B22F 12/17; B22F 12/88

(52) U.S. Cl. CPC B29C 64/379; B33Y 30/00; B33Y 40/00; B33Y 50/00; B29C 64/386; B22F 12/88; B28B 1/001; B22F 10/80; B22F 12/90; B22F 12/17; B29C 64/295

(57) ABSTRACT

An accessory device used in combination with a solid-state additive manufacturing system is described. In some configurations, the accessory device can be used in combination with an additive manufacturing system, such as a solid-state additive manufacturing system, to enable printing of large-scale and complex objects, where the objects are much larger than those printed with existing solid-state manufacturing systems. The disclosed accessory device used in conjunction with the a solid-state additive manufacturing system is capable of manufacturing non-hollow (solid), partially-hollow or completely-hollow objects via different methods.

### PRIORITY APPLICATION

This application is related to, and claims priority to and the benefit of, U.S. Provisional Application No. 63/062,266 filed on Aug. 6, 2020, the entire disclosure of which is hereby incorporated herein by reference.

### TECHNOLOGICAL FIELD

Certain embodiments are related to devices that can be used with solid-state additive systems to enable production of large parts. More particularly, certain embodiments relate to a device that is used in conjunction with an additive system to form a part or other component from material received from the additive system.

### BACKGROUND

Additive manufacturing (AM) can produce multi-functional and multi-material parts, but has some limitations. Very often substantial differences exist between interfacial and non-interfacial material micro-structures leading to inhomogeneous properties along specific sites and directions. In such cases, the fabricated parts exhibit inferior properties in comparison to the properties of the bulk material.

### SUMMARY

Certain aspects of devices that can be used in combination with additive manufacturing systems are described.

In an aspect, an accessory device used in a combination with an additive friction-based fabrication system or a solid state additive manufacturing system is described. In certain embodiments, the device enables manufacturing of large and complex parts, and wherein the device in conjunction with a solid state additive manufacturing system is configured to move and/or rotate the printed part in x-, y- and/or z-direction, or any combination of them. For example, a device can be used in a combination with an additive friction-based fabrication system or a solid state additive manufacturing system (e.g., a MELD® system). For example, the device enables manufacturing of large and complex parts, which parts are not generally possible to be printed with an original working platform of the MELD® system, and where the device in conjunction with a MELD® system has a capability to move and/or rotate the printed part in x-, y- and/or z-direction, or any combination of them. If desired, the system can also include other features such as, for example, subtractive manufacturing features in addition to additive manufacturing features.

In certain embodiments, the device is configured to enable manufacturing of large parts by any of the following methods: layer-by-layer printing, coating, joining or repairing of existing workpieces, or any combination of them. In other embodiments, the device is configured to enable adding certain features to pre-fabricated large objects.

In certain examples, the device comprises, or is used in combination with, one or more robotic arms, gantry, moving frame, crane, parallel manipulator and others to enable the required fabrication and movement of large printed parts.

In some examples, the device is configured for use with a 3-axis stationary machine to provide heating and/or cooling during the printing process.

In other examples, the device is configured for use with a 3-axis stationary machine to provide additional field, electric field, atmospheric field or magnetic field, vibration, temperature, ultrasound or light, or any combination of them, to control the microstructure and the mechanical strength of printed parts.

In certain embodiments, the device is configured for use with the 3-axis stationary machine that comprises various sensors and detectors to monitor, measure and/or control important process parameters, such as temperature, pressure, torque, length or width of printed parts.

In certain examples, the device is configured to enable fabrication of non-hollow (solid), partially-hollow or completely hollow parts, or any combination of them.

In other embodiments, the device is configured to enable fabrication of different large shapes, such as cylindrical, rectangular, square-like, oval, hexagonal, octagonal, and others.

In some examples, the device is configured to enable fabrication of tapered parts, e.g. tapered cylinders, tapered pyramids, etc.

In other examples, the device is configured to enable fabrication of hollow parts where the part wall thickness changes along one of the axes.

In certain embodiments, the device is configured to enable fabrication of tilted parts.

In some embodiments, the device is configured for use with a 3-axis stationary machine and is positioned in a such way that together they could move the printed part in addition to the movement of the MELD® system around the device.

In another aspect, a method of manufacturing large scale and complex parts comprises using a device as described herein in combination with a solid state additive manufacturing system, e.g., a MELD® manufacturing system, where the method enables manufacturing of larger parts than those possible with existing solid state manufacturing systems, e.g., than with the existing MELD® manufacturing platform.

In certain embodiments, the method comprises layer-by-layer printing, coating, joining, repair, or any combination of them. In other embodiments, the method utilizes one, two or more filler materials for manufacturing large complex-shaped parts.

In another aspect, a solid state additive manufacturing system comprises a material feed system, tooling configured to receive material from the material feed system and print the received material on a substrate, a device configured to receive the substrate, and a processor electrically coupled to the tooling and the device, wherein the processor is programmed to control the tooling and to control movement of the device to print the received material onto the received substrate on the device to form a printed part.

In certain embodiments, the device is configured to move and/or rotate the printed part in x-, y- and/or z-direction, or any combination of them. In other embodiments, the tooling can move, e.g., is configured to move, in 3-dimensions to print the material onto the substrate and form the printed part.

In some embodiments, the device comprises, or can be used in combination with, one or more of a robotic arm, a gantry, a moving frame, a crane, a parallel manipulator and combinations thereof.

In certain embodiments, the solid state additive manufacturing system comprises heating means or cooling means for heating or cooling the substrate, respectively, and/or for heating or cooling the received material or heating or cooling the printed part.

In other embodiments, the solid state additive manufacturing system comprises a stimulating device, e.g., magnet, electric field generator, radio frequency generator, piezoelectric device, laser, lamp, motor, etc., for providing an additional field, an electric field, a magnetic field, vibration, ultrasound or light, or any combination of them, to control the microstructure and the mechanical strength of printed part.

In some examples, the device is configured to permit printing of non-hollow (solid), partially-hollow or completely hollow parts, or any combination of them.

In additional examples, the device is configured to permit printing of different large shapes, such as cylindrical, rectangular, square-like, oval, hexagonal, octagonal, and others.

In some embodiments, the device is configured to permit printing of tapered parts, e.g. tapered cylinders, tapered pyramids, etc.

In other embodiments, the device is configured to permit printing of hollow parts where the part wall thickness changes along one of the axes.

In additional embodiments, the device is configured to permit printing of tilted parts or non-planar parts.

Additional aspects, embodiments, features and elements are described further below.

### BRIEF DESCRIPTION OF THE SEVERAL VIEWS OF THE DRAWINGS

Certain aspects, embodiments, configuration, features and elements of the technology disclosed herein are described with reference to the accompanying figures in which:

FIG. 1 schematically illustrates an additive manufacturing system.

FIG. 2A and FIG. 2B are cross-sectional views of the feeding unit and spindle housing for solid rod-like filler material (FIG. 2A) and powder/pellet filler material (FIG. 2B).

FIG. 3A is a schematic cross-sectional view of a spindle and a tool.

FIG. 3B is a schematic cross-sectional view of a tool with optional injection ports and side cutters.

FIG. 3C is a schematic cross-sectional view of a tool with optional hollow pin and nubs.

FIG. 3D is a schematic cross-sectional view of a tool with optional replaceable nubs.

FIG. 3E, FIG. 3F, FIG. 3G, FIG. 3H, FIG. 3I, FIG. 3J and FIG. 3K illustrate cross-sections of different tool shapes.

FIG. 4A, FIG. 4B, FIG. 4C, FIG. 4D, FIG. 4E and FIG. 4F are bottom views of tool shoulders with various throat openings.

FIG. 4G, FIG. 4H, FIG. 4I, FIG. 4J, FIG. 4K and FIG. 4L are bottom views of tool shoulders with various nubs, throat openings and shoulder features.

FIG. 5A, FIG. 5B and FIG. 5C illustrate cross-sectional views of various tapered tool shoulder geometries.

FIG. 5D and FIG. 5E illustrate cross-sectional views of tapered hollow pin with flat and tapered shoulder.

FIG. 6A and FIG. 6B illustrate cross-sectional views of tools with different passageway (throat) geometries.

FIG. 6C illustrates a cross-sectional view of a tool with multiple openings for powder and pellet filler materials.

FIG. 6D illustrates a cross-sectional view of a tool with pin with a throat with side openings intended for additive welding with powder and/or pellet material.

FIG. 6E and FIG. 6F illustrate cross-sectional views of tools with multiple passageways.

FIG. 6G, FIG. 6H and FIG. 6I illustrate bottom views of tool shoulders with multiple passageways and optional static or replaceable nubs.

FIG. 7A, FIG. 7B, FIG. 7C, FIG. 7D and FIG. 7E schematically presents the process of material deposition on a workpiece with the proposed AFS system.

FIG. 8A and FIG. 8B schematically illustrate the AFS process of depositing filler material comprising reinforcing particles, such as CNTs or carbon fibers through the tool throat. Without preferential transverse moving of the tool along the workpiece surface, random orientation of anisotropic reinforcers is achieved (FIG. 8A). By application of an external field, e.g. electric or magnetic field and/or preferential transverse moving of the tool, a preferential orientation of CNTs or carbon fibers is achieved (FIG. 8B).

FIG. 9A and FIG. 9B schematically illustrates the welding between two structures made of dissimilar materials with the AFS system. The weld between the two structures is filled with the filler material (FIG. 9A) acting as a sealant, or the weld is filled with the filler material and reinforcing particles for additional reinforcement of the bond generated between the structures (FIG. 9B).

FIG. 10 schematically presents the process of repairing a defective tubular structure having a crack with the present AFS system using a backing plate.

FIG. 11A schematically illustrates the process of in-situ making material blocks, such as MMC, metal-polymer composites, reinforced composites and other materials, by depositing the filler material on a backing plate and subsequent separation from it.

FIG. 11B is a schematic of in-situ generation of a surface reinforced material, viz. MMC or composite—mixing, homogenization, consolidation—as it moves from the feeding unit through the spindle and the tool on the surface of backing plate.

FIG. 11C is a schematic of in-situ reaction and generation of a polymer material, IPN or SIPN by mixing and causing polymerization reaction of one or more monomers and initiator added at the last stage with optional application of an external energy source.

FIG. 12A is a schematic of fabrication of sandwich structures where the sandwich structure comprises stiffeners in-between two plates.

FIG. 12B is a schematic of fabrication of sandwich structure where the sandwich structure comprises a foam layer in-between two plates.

FIG. 13A is an illustration of some components or an additive (or additive/subtractive) system that includes tooling and a device with a robotic arm, e.g., an accessory device.

FIG. 13B is an illustration showing a parallel manipulator that can be used with an additive (or additive/subtractive) system.

FIG. 14A, FIG. 14B, FIG. 14C, FIG. 14D, FIG. 14E, FIG. 14F, FIG. 14G, FIG. 14H, FIG. 14I, FIG. 14J, FIG. 14K and FIG. 14L are illustration showing some of the shapes that can be produced using a device.

FIG. 15A and FIG. 15B are block diagrams showing some of the components that are present in a system including an accessory device.

FIG. 16 is an illustration showing tooling positioned adjacent to other tooling.

FIG. 17 is an illustration showing an additive manufacturing system with an accessory device.

FIG. 18 is an illustration showing a rotary table.

FIG. 19A and FIG. 19B are photographs showing printed parts produced using an additive manufacturing system and a rotary table.

### DETAILED DESCRIPTION

Reference will be made in detail to various exemplary embodiments and configurations. It will be understood by the person having ordinary skill in the art, given the benefit of this disclosure, that the following exemplary embodiments are not intended to limit the scope of the technology or claims. Rather, the following text provides a user-friendly and detailed illustration of certain aspects and features. Any combination of different embodiments can be used to manufacture large-scale and complex-shaped objects with the aid of device. The size, shape and number of device(s) might vary in order to produce the desired large complex objects which large size could not be produced by the existing MELD® working platform. The device can be used, for example, to layer-by-layer print pristine objects, as well as coat, seal, join or repair objects, manufactured in advance by a MELD® process or other processes known in the art. The MELD® system with the device is also capable of enabling any combination of layer-by-layer printing and other methods. Furthermore, the device enables adding printed features, such as reinforcing structures, to pre-fabricated large parts made by a MELD® process or other suitable processes. In general, additive manufacturing (AM) refers to a process of joining materials to make multi-dimensional objects usually by layer-by-layer deposition.

It should be noted that in the examples and description provided in this application, various modifications can be made and are also intended to be within the scope of the technology. For example, the described manufacturing methods can be practiced using one or more of the method steps described, and in any order. Further, method steps of one method may be interchanged and/or combined with the steps of other methods described and/or with method steps known to those of ordinary skill in the art. Likewise, the features and configurations for particular tooling described in this application may be omitted, interchanged, and/or combined with other features described or known to those of ordinary skill in the art. One or more devices in a combination with other supporting elements (robotic arms, gantries, cranes, moving frames, parallel manipulators, etc.) could be used (either alone or together) and interchanged in any order to provide the required movement of the printed part.

Without wishing to be bound by any particular theory or any one specific mode of operation, the MELD® additive manufacturing technology can overcome at least some of the drawbacks of common AM technologies, such as fusion-based AM processes, cold-spray deposition and others. MELD® technology comprises a solid-state thermo-mechanical layer-by-layer printing of a single material, multiple materials or a proprietary material composition on a working platform or deposition on a previously manufactured workpiece. For example, some instances of a no-melt MELD® deposition can be based, at least in part, on friction between the material deposited via the MELD® tool comprising an internal passageway and the workpiece, where the frictional and other forces, as well as the generated heat cause significant materials' deformation in the vicinity of the rotating tool. The materials adjacent to the tool (the filler material supplied via the tool and the surface material layer of the workpiece) soften, i.e. are in so-called malleable state, and are mechanically-stirred and mixed together. Additional forces, e.g., shear or other forces, may also come into play in the process. Due to its no-melt nature, MELD® technology can yield strong interfaces between deposited layers of same or dissimilar materials or materials that form eutectic mixtures and could not be joined by other technologies known in the art. Furthermore, the MELD® manufacturing system offers the possibility of manufacturing parts via hybrid additive manufacturing, i.e. performing the additive and subtractive steps, while overcoming the challenges associated with the competitive technologies.

One of the challenges of the AM technologies is the size of the printed parts. Many of the competitive technologies are limited in size due to the limitations of the inert gas/vacuum chamber and/or the powder bed. The open-atmosphere MELD® technology does not have these types of limitations, but the size of the printed parts is limited by the working platform of the MELD® system. Therefore, a desirable attribute in an accessory device/system enables printing of large parts with the existing MELD® system, which parts will be larger than those manufactured by the MELD® system.

In the various illustrations described herein, it should be understood that the device used with an AM system may be a combination of different devices that are used together and not just a single device, e.g., not just a single robotic arm or a single gantry.

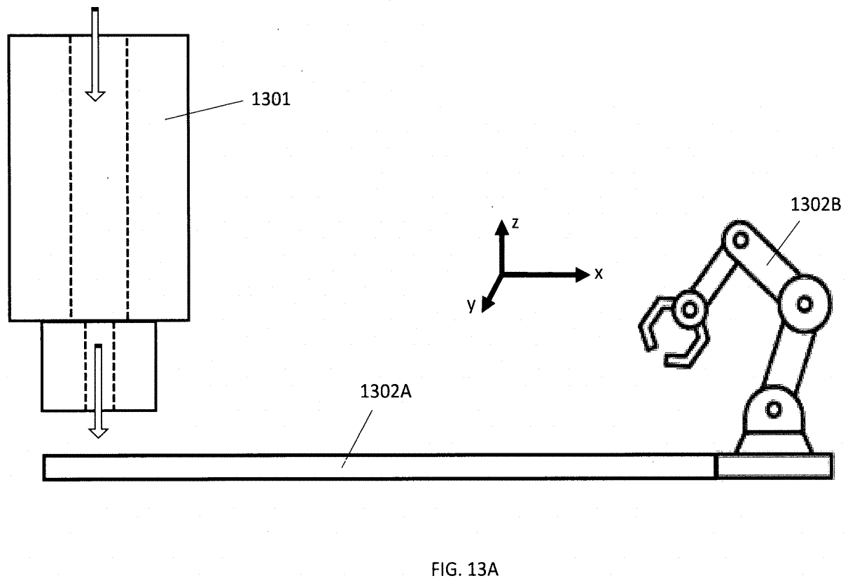

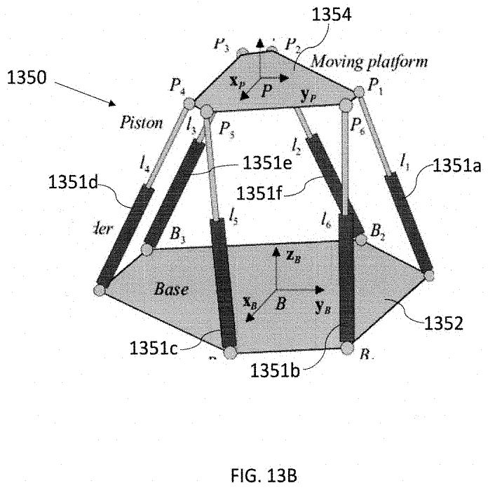

In certain embodiments, the device in combination with 3-axis stationary machine enables printing and moving large complex-shaped parts, which are being built in any of the three linear axes, e.g. x, y and z. The device may be referred to in some instances herein for convenience as an “accessory device.” In some embodiments, the 3-axis movement is enabled with a structure (element), such as but not limited to overhead movable bridge-like structure, gantry or robotic arm. In another embodiment the device uses alternate means in addition to the moving table platform, such as but not limited to robotic arm, gantry, crane etc. to build components in vertical, horizontal and other axis. An example of a MELD® system and a device with a robotic arm is shown in FIG. 13A. A robotic arm 1302B of a device 1302A can be used in combination with tooling 1301 to print a layer of material into a support of the device or onto an object placed into the support. The support may become part of the final printed part or may act only as a support substrate that can receive the material from the tooling during the material deposition process. In general, the tooling may rotate circumferentially and a suitable pressure and material can be used to print material in the tooling onto the support of the device. The device can move in three dimensions to permit printing of complex shapes with different heights, thicknesses and individual features. An example of a parallel manipulator or Stewart platform 1350 that can be used with a MELD® or other AM system is shown in FIG. 13B. Without wishing to be bound by any one configuration, a Stewart platform is a type of parallel manipulator that has six prismatic actuators, commonly hydraulic jacks or electric linear actuators (1351a-1351f), attached in pairs to three positions on the platform's baseplate 1352, crossing over to three mounting points on a top plate 1354. All 12 connections can be made by universal joints. Devices placed on the top plate can be moved in the six degrees of freedom in which it is possible for a freely-suspended body to move: three linear movements x, y, z (lateral, longitudinal, and vertical), and the three rotations (pitch, roll, and yaw). The parallel manipulator can be used with a AM system to provide final parts as noted herein.

In some embodiments, the movements in the x, y and z-direction are continuous, while in other embodiments, the movements are discrete or discontinuous. For example, the tooling 1301 can be used to print segments of a part that are separated from each other spatially. Additional tooling (not shown) which may include the same or different material can then print a material to couple the various segments to each other in a subsequent process. In yet another embodiment, manufacturing of a large complex part can be performed by a combination of continuous and discontinuous movements provided by the device.

In certain embodiments, the device is used with n-axis stationary machines which enable continuous or discontinuous movements along multiple axes. For example, n may be 2, 3, 4, 5 or more. In one instance where n=5, the three linear axes and two rotational axes can be used during operation. Thus, the MELD® system and the device enable the manufacture of large objects with highly-complex forms.

In some embodiments, the disclosed device is configured to provide means of printing various non-hollow solid shapes, such as but not limited to the following shapes: cylindrical, rectangular, square-like, oval, etc. Hollow shapes can be formed by printing around an insert or block or be printing of the various sides or faces directly without any insert or block being present. In other embodiments the disclosed device is configured to provide means of printing different partially-hollow shapes, such as but not limited to the following shapes: cylindrical, rectangular, square-like, oval, hexagonal, octagonal, etc.

In yet other embodiments, the disclosed device is configured to provide means of printing different hollow shapes, such as but not limited to the following shapes: cylindrical, rectangular, square-like, oval, etc.

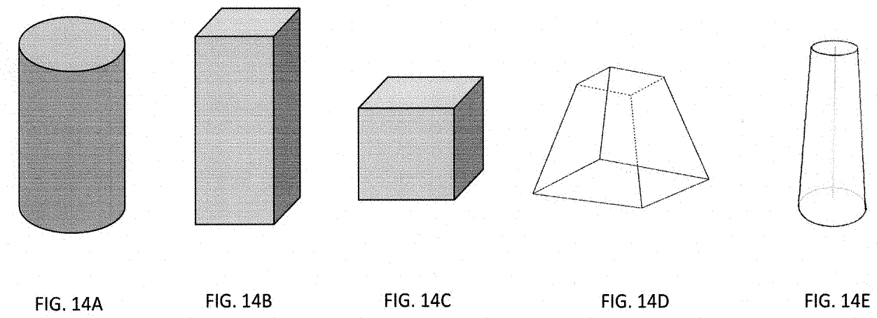

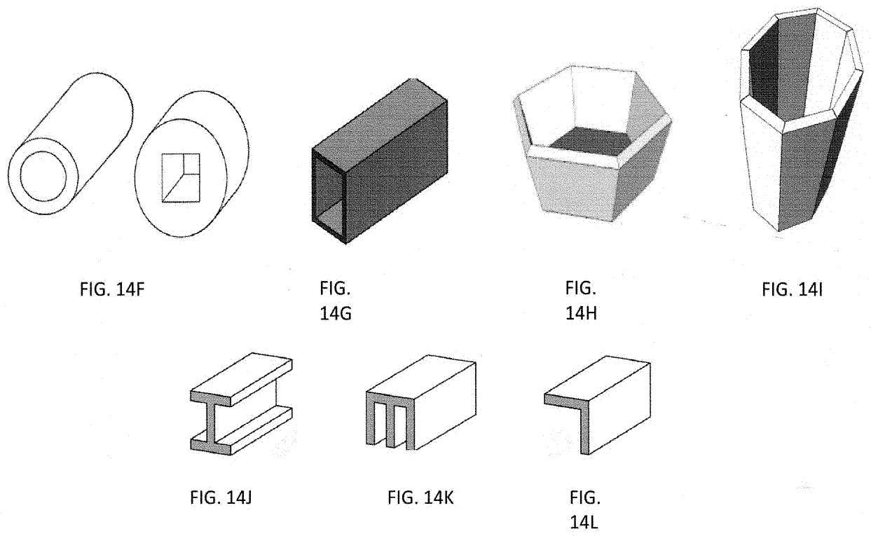

FIGS. 14A-14I presents some of the shapes possible to be printed with the MELD® system equipped with a device. Examples include but are not limited to: solid cylinder (FIG. 14A), solid rectangular object (FIG. 14B), solid cube (FIG. 14C), truncated pyramid (FIG. 14D), truncated cylinder (FIG. 14E), hollow cylinders (FIG. 14F), hollow rectangular channel (FIG. 14G), one-side closed hollow hexagonal shape (FIG. 14H), hollow octagonal shape (FIG. 14I) and other shapes (FIGS. 14J, 14K and 14L).

In certain embodiments, the device is configured to print closed hollow shapes, such as but not limited to the following examples: closed cylinders, closed rectangular shapes, closed hexagonal shapes, etc. In some embodiments, the device can be used to print hollow structures which gradually change their shape and/or the thickness of the printed wall, such as but not limited to tapered cylinders, tapered pyramids, etc. In other embodiments, the device can be used to print tilted structures of different shapes.

In certain embodiments, a large-scale complex-shape part can be printed layer by layer using the device and an AM system such as, for example, a MELD® system. In other embodiments, a previously fabricated part produced by a MELD® process or by other processes known in the art, can be being coated with a MELD® process with the aid of the device. In another embodiment, previously fabricated parts can be joined together by a MELD® process with the aid of the device. In yet another embodiment, previously fabricated and used part is being repaired with a MELD® process with the aid of the device. In some other embodiments, certain features are being added to pre-fabricated parts with a MELD® process with the aid of device. Examples include but are not limited to adding rings around pre-fabricated long pipes, adding strengthening (reinforcing) features to large plates, etc.

In a particular embodiment, the MELD® manufacturing system can move around the large 3-axis or 5-axis stationary machines with device(s) in order to enable manufacturing of very large parts with complex shapes. In another embodiment, the device with the 3-axis or 5-axis stationary machine is equipped with one, two or more sensors and detectors to monitor, measure and/or control various process parameters, including but not limited to temperature, pressure, torque, stress, length and width of the deposited parts.

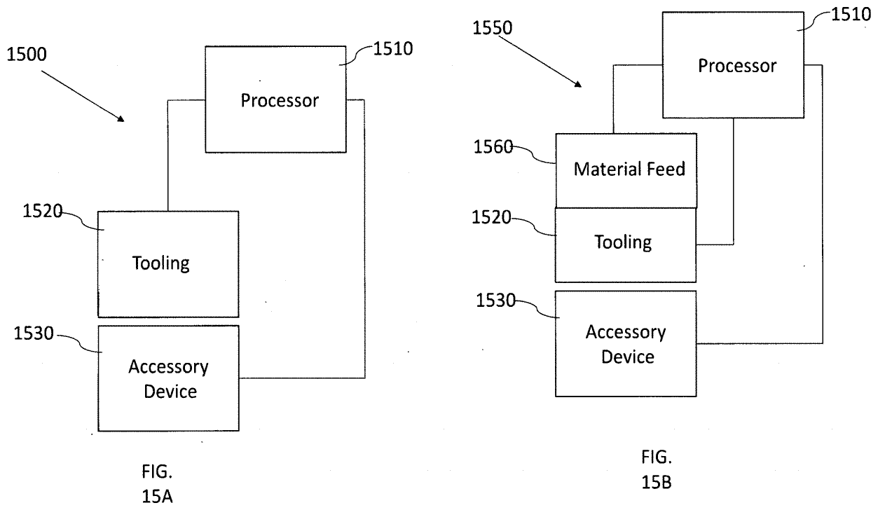

In certain embodiments, a block diagram of a system including a device is shown in FIG. 15A. The system 1500 comprises a processor 1510 that is electrically coupled to tooling 1520 and an accessory device 1530. The tooling 1520 may comprise one or more materials to be deposited on a support which can be part of the device 1530 or may be separate from the device 1530. While not required, the tooling 1520 may comprise a shoulder that the material is passed through. For example, use of tooling with a shoulder can permit continuous deposition by being able to feed material into the tooling. In some instances, a system 1550 (see FIG. 15B) can also include a material feed sub-system 1560 to provide material to the tooling 1520 as the part is being printed. The material feed sub-system 1560 can feed bar stock, scrap, recycled material, powder, fibers or other forms of materials to the tooling 1520 for printing.

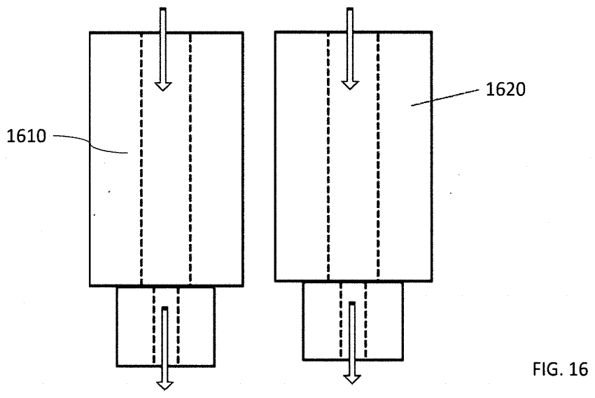

In some embodiments, the device can be used with more than a single tooling device to print material onto a substrate. An illustration is shown in FIG. 16, where tooling 1610 is positioned adjacent to tooling 1620. The different tooling 1610, 1620 can deposit the same material or different materials as desired, e.g., the materials can be deposited simultaneously or sequentially using the tooling 1610, 1620. In addition, the tooling 1610, 1620 can be co-axial, parallel or arranged at a certain angles relative to each other, e.g., one tooling may be positioned orthogonal and offset relative to another tooling position to build up material against a side of already printed material. If desired, different tooling can be arranged in the form of an array with different tooling row members, tooling column members or individual tooling members being configured to print the same or a different material as other tooling members in the array. The tooling generally rotates circumferentially when in use as material is printed onto a surface of a substrate. Rotation can create friction, heat and pressure to assist in the printing process.

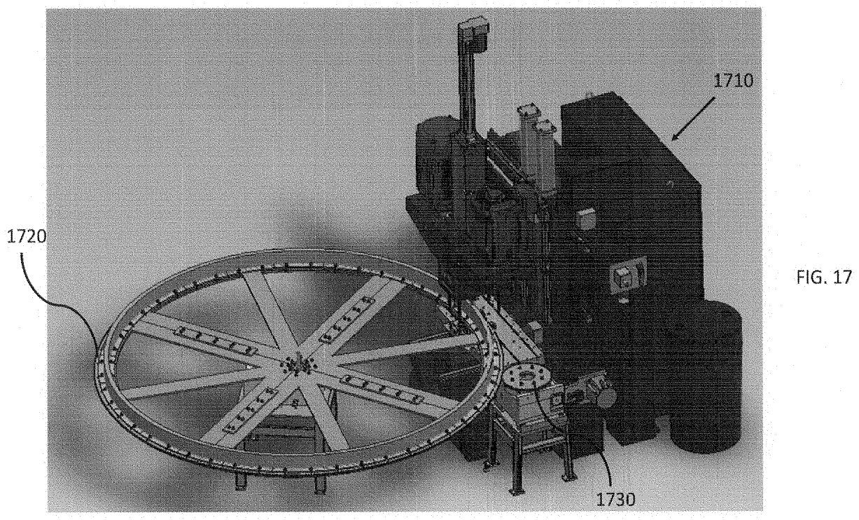

In certain embodiments, the accessory device may take the form of a rotary table as shown in FIG. 17. The rotary table 1720 can be used with an AM system, such as a MELD® system 1710, and a gear 1730 to turn the rotary table 1720 at a desired speed. The rotary table 1720 can move in 1-, 2- or 3- or more dimensions to deposit material on top of support of the rotary table 1710. If desired, the rotary table 1720 can be combined with another device to achieve additional dimensional control for deposition, e.g., placement of a parallel manipulator on a rotary device or placement of a rotary device on a parallel manipulator can provide additional dimensional control.

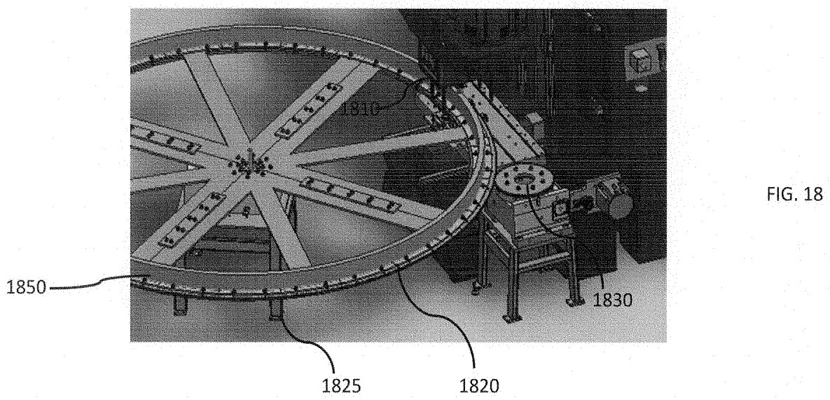

FIG. 18 is a close-up view of one configuration of a rotary table showing a rotary table 1820 with a continuous and constant outer radius of a desired size. Tooling 1810 can deposit material onto the upper surface of the rotary table 1820 to form a part on a substrate 1850. The gear 1830 shown in FIG. 18 can control how fast the table 1820 rotates. Alternatively, the table 1820 can include a motor, a motor and shaft, can be moved manually or by other means. The gearing 1830 or motor that rotates the table 1820 can be part of the AM system or may be separate from the AM system. For example, the gearing or motor can be controlled by the AM system or by separate subsystem. An additional support structure 1825 is shown under the rotary table 1820 to stabilize the table 1820 during movement and to assist in supporting the part that is printed on the substrate 1850. The substrate 1850 may form part of the final part of may be separated from the printed part after production.

The exact material used in the systems described herein may vary and includes, but is not limited to, metals, plastics, ceramics and other materials. In addition, where a rotary table is used, the table may rotate at many different speeds, e.g., from 1-2 inches per minute up to 100 inches per minute, depending on the desired deposition speed and materials used. If desired, the rotary table can rotate in a clockwise and counter clockwise direction and may rotate in different directions as different features or areas of the part are printed. The overall diameter of the rotary table may be adjusted by inserting additional radial segments into the rotary table. Alternatively, different size rotary tables can be used to print different size parts. If desired, a rotary table positioned within another rotary table can be used to deposit two separate parts at the same time. The parts could be joined by ribs, arms or other structures to each other once printed.

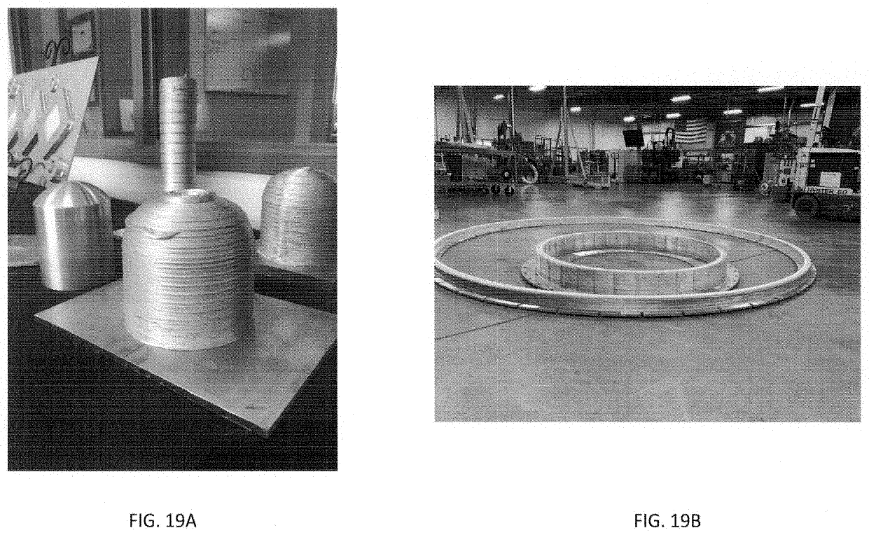

In certain embodiments, the printed part need not be planar and may include dome shapes, areas with increased thickness or height or otherwise non-planar areas. Illustrations are shown in FIGS. 19A and 19B. The outer large part shown in FIG. 19B has a diameter of about 10 feet and a wall thickness of about 2 inches.

In certain embodiments, a material may be applied, e.g., coated, extruded, painted, brushed, etc., onto a support table prior to printing of the part. For example, a thin metal layer can be added to a non-metal substrate so printing using an AM system can be performed on top of the deposited thin metal layer. In other instances, the substrate itself may be metal or a ceramic and may be printed directly on an upper surface. A single material or multiple different materials can be printed onto the substrate, e.g., together or in separate layers or segments. In some examples, material can be printed around another material, e.g. a foam or insert, to form a final part. The foam or insert can be left in place or removed after printing to form a hollow part.

In some embodiments, the device may be part of a larger system that is used to assemble a final article. For example, the accessory device can be a robotic arm that is used to print the part using an AM system and then places the printed part on other components which are joined or coupled to each other to form a final article such as, for example, a vehicle, aircraft, spacecraft or the like. If desired, the robotic arm can be used to print a part directly onto another sub-assembly of the article to build up the part into the sub-assembly. A gantry or other device may be used where large parts are printed and/or moved around.

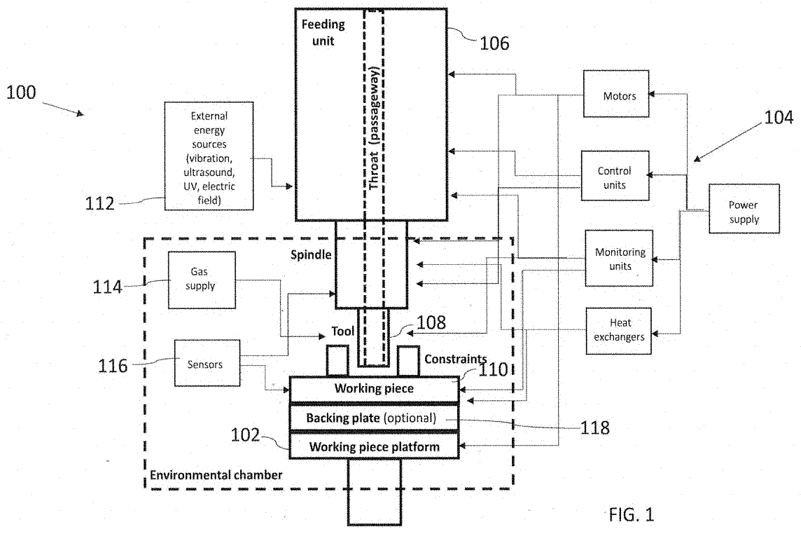

In certain instances, one embodiment of a MELD® system can be configured as an additive manufacturing system (AM) or an additive friction-based fabrication system (AFS) as shown in FIG. 1. The system 100 comprises a working piece platform 102, a process control system 104 (e.g., a processor, motors, power supply, control units, monitoring units, etc.), motors and variable frequency drives; one or more feeding units 106 can dispense consumable filler material through a non-consumable tool 108 onto substrate of a working piece 110. For example, friction-based fabrication tooling can include a non-consumable body formed from material capable of resisting deformation when subject to frictional heating and compressive loading and a throat defining a passageway lengthwise through the body and comprising means for exerting normal forces on a material in the throat during rotation of the body. Additional optional components such as an external energy source 112, gas supplies 114, sensors 116, an optional backing plate 118, etc. may also be present in the system 100.

In certain examples, a machine can be used that includes, in part, a platform a control process software, motors and variable frequency drives. The platform can be a carrier of feeding unit, tool, spindle, process-controlling software, motors and variable frequency drives. Process control software can control the tool rotation speed and substrate movement speed. Motors can run the tool through a spindle. A variable frequency drives control of the tool rotation speed through the motors and spindle. The accessory device can be controlled by the AM or AFS machine or through separate controls if desired.

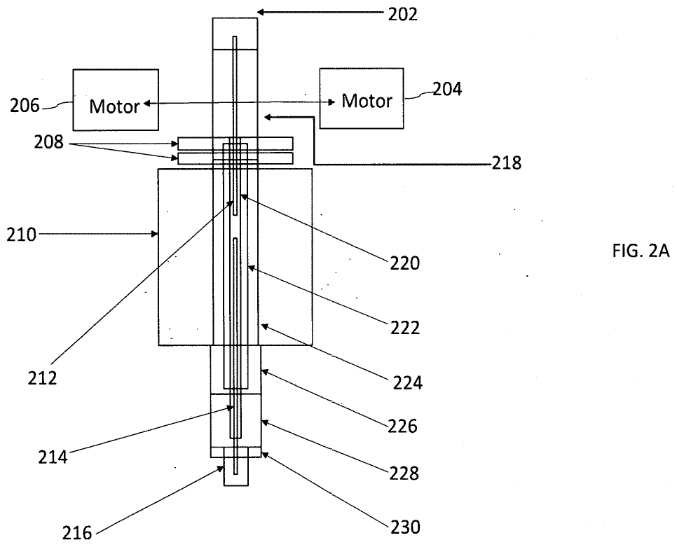

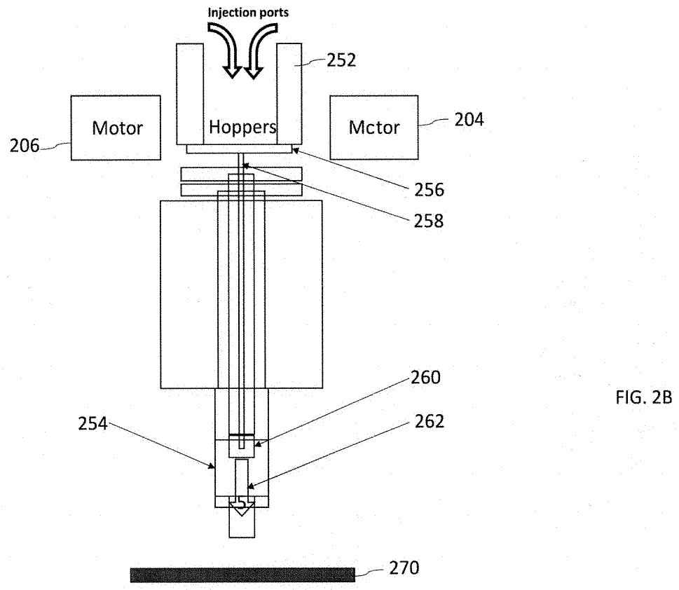

For example, in one configuration the system can include a feeding unit for solid- (rod-) like filler material (FIG. 2A) and for powder- or pellet-type filler material (FIG. 2B) comprising an actuator 202, a push rod 202, and optional guide rods and cross member. The actuator 202 provides a downwards force to push feedstock or filler 214 onto substrate (see, e.g., 270 in FIG. 2B) through the push rod 214. The guide rods and cross member can be present to stabilize the push rod 214. Furthermore, the embodiment includes a spindle housing 210 for solid (rod) filler material 214 (FIG. 2A) or a hopper or ports 252 for powder- or pellet-type filler material (see FIG. 2B). The system shown in FIG. 2A can also include motors 204, 206, drive pulleys 208 for the spindle, a tool 216, a solid feed push rod and actuator stand 218 (can provide travel distance between the actuator and a feed rod), a solid feed pass through 220, a secondary spindle (floating/non-driven) 222, spindle parts 224 to impart drive to the lower spindle/adapter, a lower spindle 226, a tool holder 228 and a pressure plate 230. The system shown in FIG. 2B can also include a modified tool holder 254, a hopper lateral delivery system 256, a mixing downtube 258, an auger drive mechanism 260, and a powder draw down mechanisms 262, e.g., wipers or other devices. In some embodiments, the system can include bearings, oiler system spindles and a hole in the center. For example, the bearings allow rotation of spindles, the spindles drive the tool for rotating through a tool holder, and a hole in the center allows feedstock to get through the spindles. In another embodiment, injection ports can be installed around the feeding unit (i.e. around hopper 252 in FIG. 2B) to add additives (lubricants, stabilizers, catalysts, initiators and others) to the filler material.

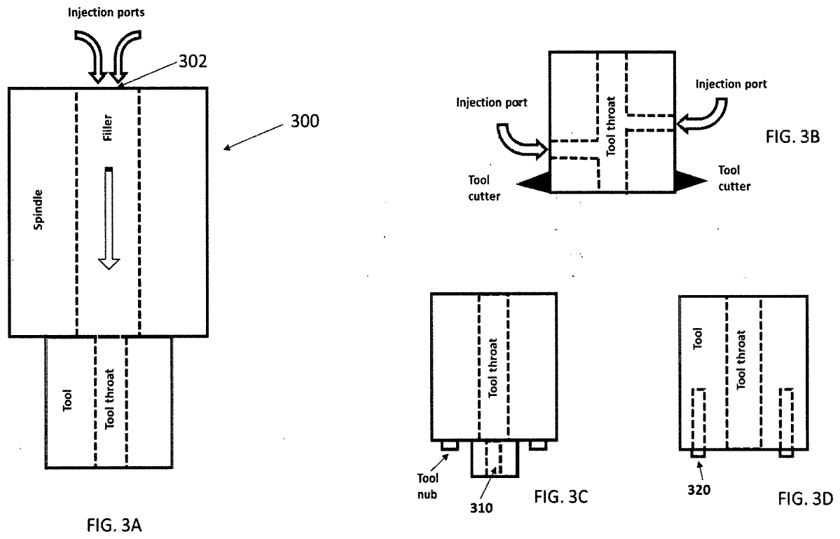

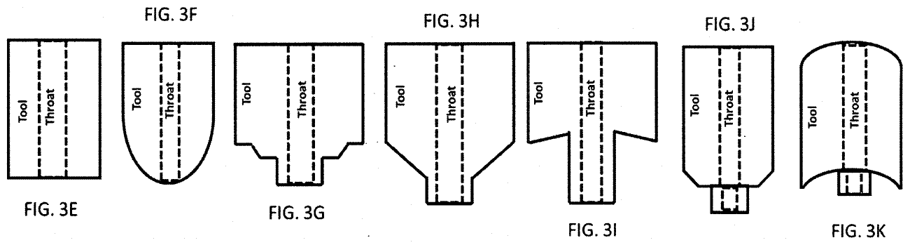

In certain embodiments, a tool holder with a throat can be used. The tool holder can hold and rotate the tool, and the throat allows feedstock to get through it. Another embodiment can include a tool changer, which enables changes of one or more or multiple tools (e.g., the same tool, such as replacing a worn tool of the same type, or a different tool, such as for different functionality) with variety of tool geometries and tool throat designs to be implemented during the deposition process. In some embodiments, the tool 300 has a throat (passageway) that is in operable communication with the spindle passageway (see FIG. 3A). In other embodiments, one or more injection ports 302 are installed to add additives (lubricants, stabilizers, catalysts, initiators and others) to the filler material in the main passageway of the spindle (FIG. 3A).

In some embodiments, the tool can be equipped with certain accessories, such as tool cutters located on the peripheral side of the tool are being used for cutting “extra” material that is flashing during the deposition process (FIG. 3B). In certain configurations, a non-rotating tool body comprises one or more injection ports with internal passage connecting the port(s) to the main throat of the tool for supplying additives to the main filler material, such as lubricants, cross-linkers, initiators, catalysts, stabilizers and so on (FIG. 3B).

In some embodiments, a pin with a throat might extend from the tool shoulder, where the pin throat 310 is in operational communication with the tool throat (FIG. 3C). A pin in all embodiments is an optional component of the AFS system. The pin enables better stirring of the surface region of the workpiece and the filler material. In certain embodiments, the hollow pin might contribute to a better welding and joining of dissimilar materials where the supplied filler material from the pin throat acts as a sealant. In yet another embodiment the weld or the space between two structures to be joined or to be welded is filled with reinforcing materials (reinforcing fibers or particles, CNTs and so on) which further strengthen the bond between the structures. In some embodiments, the tool shoulder facing the workpiece comprises at least two nubs made of the same or different material as the tool material (FIG. 3C).

In yet other embodiments, the nubs 320 are replaceable (FIG. 3D). The replaceable nubs will extend significantly the tool life-time as it allows only the nubs to be replaced after they undergo certain wear and not the whole tool. Moreover, the nubs 320 can be made of stronger and more expensive material than the tool material, e.g. diamond or sapphire or PCNB or W-Rh-Hf or Ti, and thus, provide less expensive tool but still enough strong to withhold the extreme-wear stirring conditions.

In some embodiments the tool geometry varies with the shoulder having flat, convex or concave shape or any other shape (see FIGS. 3E-3K).

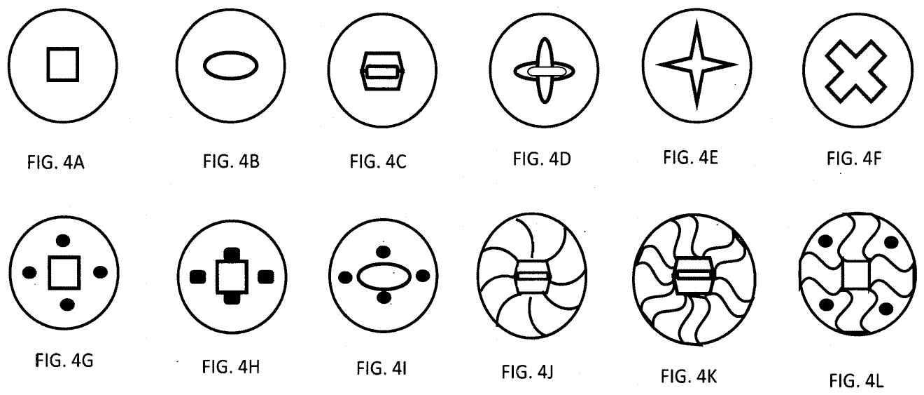

In some embodiments, the tool body comprises an internal passageway, where the passageway might have a variety of cross-sectional shapes. In some embodiments, the internal passageway has a square, circular, oval, rectangular, star-like, hexagonal or any other cross-sectional shape (see, e.g., FIGS. 4A-4F).

In some embodiments, the tool shoulder might have certain surface features (spiral, propeller-type and so on) helping the efficacy of the material displacement and its stirring underneath (FIGS. 4G-4L). Furthermore, in certain embodiments, beside the surface features of the shoulder, the nubs having various shapes and sizes are displaced at different locations on the tool shoulder (FIGS. 4G-4L).

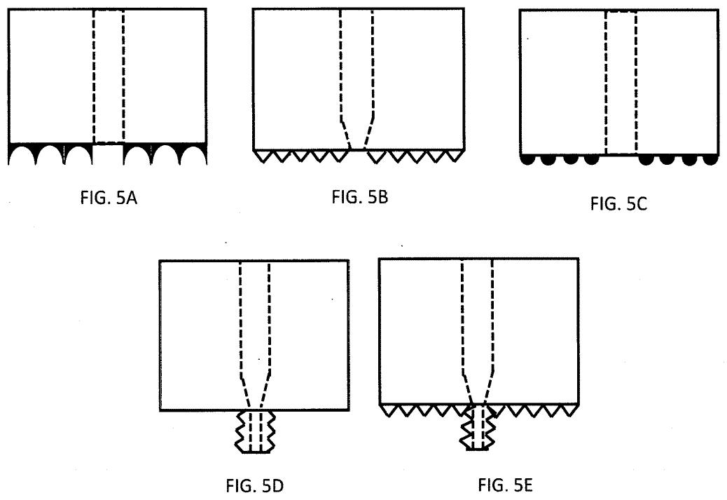

In another embodiment, the tool comprises tapered shoulder and or/tapered hollow pin (FIGS. 5A-5E). The tapered shoulder and/or pin enable better stirring in the surface area of the workpiece with the filler material. The tapered zone on the shoulder and the pin might be filled with features of same or various shapes and sizes.

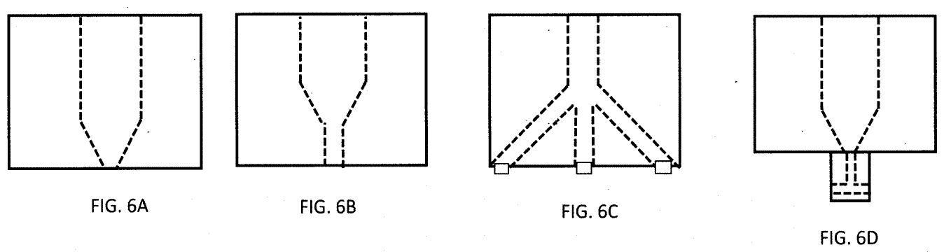

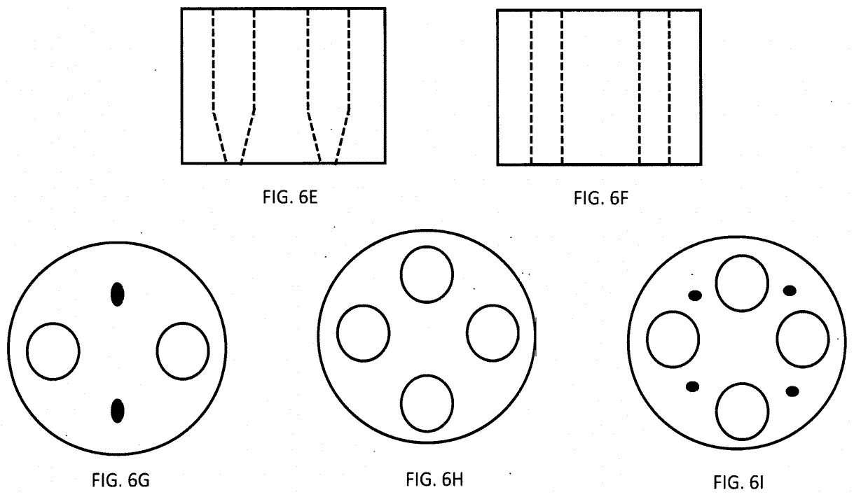

In certain embodiments, the passageway of the spindle in communication with the tool passageway may change the cross-sectional shape and size (FIGS. 6A and 6B). Changes in the tool passageway shape and size are possible as well (FIG. 6C). In some embodiments, the spindle and/or the tool might have multiple passageways (FIGS. 6A, 6B, 6C and 6D). In yet another embodiment, the tool comprises a passageway that branches in two or more openings toward the end of the tool passageway for the filler material to cover wider area on the workpiece surface (FIGS. 6D and 6E). The tool shoulder might comprise nubs, static or replaceable, in addition to the multiple passageways (FIGS. 6G-6I). The passageways might have any cross-sectional shape. In the case of multiple passageways, passageway circular cross-section as shown in FIGS. 6G-6I are possible.

In certain configurations, a friction-based fabrication tool comprises a non-consumable member having a body and a throat, wherein the throat is shaped to exert a normal force on a consumable coating material disposed therein for imparting rotation to the coating material from the body when rotated at a speed sufficient for imposing frictional heating of the coating material against a substrate. The body can be operably connected with means for dispensing and compressive loading of the deposit material from the throat onto the substrate and with means for rotating and translating the body relative to the substrate. The body comprises a surface for trapping deposit material loaded on the substrate in a volume between the body and the substrate and for forming and shearing a surface of a deposit on the substrate. The environmental “chamber or shield” is a flexible part of the system. It provides a space enclosure around the working piece (substrate), the tool and the spindle useful when deposition in a controlled atmosphere is required. The supply of gasses in this enclosed environment enables sensitive to air (oxygen) materials to be deposited, thus avoiding oxidation of the material during the deposition. Furthermore, the enclosed space can provide certain gas environment which together with the filler materials contribute toward the final composition and/or structure of the deposited material. In this way, metal nitrides are possible to be deposited from metals and metal alloys in nitrogen environment, as well as porous structure such as Al-foams and polymer foams, are possible by blowing gasses during the deposition of the filler materials.

Other specific embodiments include friction-based fabrication tools comprising one or more of (a) a body member comprising a hollow interior for housing a deposit material disposed therein prior to deposition on a substrate; wherein the interior of the body member is shaped to exert a normal force on the deposit material disposed therein for rotating the deposit material during rotation of the tool; (b) means, in operable communication with the tool, for dispensing and compressive loading of the deposit material from the tool onto the substrate and with means for rotating and translating the tool relative to the substrate; and wherein the tool comprises a shoulder surface with a flat surface geometry or a surface geometry with structure for enhancing mechanical stirring of the loaded deposit material, which shoulder surface is operably configured for trapping the loaded deposit material in a volume between the shoulder and the substrate and for forming and shearing a surface of a deposit on the substrate.

In some embodiments, the geometry structures on tool shoulder may be nubs having various shapes and located in various (e.g., different) positions of the tool shoulder for enhancing mechanical stirring of the deposited material. In some embodiments, the tool shoulder may extend into a pin with passageway in operational communication with the tool passageway, which is particularly useful when dissimilar materials need intensive stirring and/or welding. According to some embodiments, the tool materials can be the following but not limited to tool steels, W-based materials, WC-based materials, WRe-HfC materials, W-La materials and PCBN materials.

In certain embodiments, the filler material and substrate can each be metallic materials, metal matrix composites (MMCs), polymers, ceramics, plastic compositions, such as polyolefins, polyurethanes, Teflon-type polymers, polyesters, polyacrylates, polymethacrylates, nylon, styrene, or metals independently chosen from steel, Al, Ni, Cr, Cu, Co, Au, Ag, Mg, Cd, Pb, Pt, Ti, Zn, Fe, Nb, Ta, Mo, W, or an alloy composing one or more of these metals. The filler material can be rod, powder, pellet, powdered-filled cylinder, or any combination of them.

In another embodiment, the filler material can be reinforcing material in form of micro- and nano-particles, fibers, multi-wall or single-wall carbon nanotubes (MW-CNT and SW-CNTs) and others added to a polymer or metal matrix material. In yet another embodiment, the filler material can be a composition comprising base matrix, metal or polymer, metal alloy, polymer blend or composite, with certain additives such as lubricants, stabilizers, initiators, catalysts, cross-linkers, etc.

In some examples, the means for creating normal forces on a material in the throat during rotation of the tool body may be a throat having a non-circular cross-sectional shape. Additionally, any filler material may be used as the deposit material, including consumable solid, powder, pellets, or powder-filled tube type deposit materials. In the case of powder-type deposit material, the powder can be loosely or tightly packed within the interior throat of the tool, with normal forces being more efficiently exerted on tightly packed powder filler material. Packing of the powder filler material can be achieved before or during the deposit process.

In certain embodiments, the AFS system and accessory device can be used in a method of forming a surface layer on a substrate, such as repairing a marred surface, building up a surface to obtain a substrate with a greater thickness, joining two or more substrates together, or filling holes in the surface of a substrate. Such methods can comprise depositing a material on the substrate (positioned on the device such as a rotating table) with tooling described in this application, and optionally friction stirring the deposited material, e.g. including mechanical means for combining the deposited material with material of the substrate to form a more homogenous deposit-substrate interface. Depositing and stirring can be performed simultaneously, or in sequence with or without a period of time in between. Depositing and stirring can also be performed with a single tool or separate tools, which are the same or different.

Particular methods include depositing material on a substrate using frictional heating and compressive loading of a depositing material against the substrate, whereby a tool supports the depositing material during frictional heating and compressive loading and is operably configured for forming and shearing a surface of the deposit.

In some embodiments, the tool and depositing material preferably rotate relative to the substrate. As noted herein, the substrate may also rotate or move using the devices described herein. The tool can be attached to the depositing material and optionally in a manner to allow for repositioning of the tool on the deposited material. Such embodiments can be configured to have no difference in rotational velocity between the depositing material and tool during use. The depositing material and tool can alternatively not be attached to allow for continuous or semi-continuous feeding or deposition of the depositing material through the throat of the tool. In such designs, it is possible that during use there is a difference in rotational velocity between the depositing material and tool during the deposition. Similarly, embodiments provide for the depositing material to be rotated independently or dependently of the tool.

In some instances, the depositing material is delivered through a throat of the tool and optionally by pulling or pushing the depositing material through the throat. In embodiments, the depositing material has an outer surface and the tool has an inner surface, wherein the outer and inner surfaces are complementary to allow for a key and lock type fit. Optionally, the throat of the tool and the depositing material are capable of lengthwise sliding engagement. Even further, the throat of the tool can have an inner diameter and the depositing material can be a cylindrical rod concentric to the inner diameter. Further yet, the tool can have a throat with an inner surface and the depositing material can have an outer surface wherein the surfaces are capable of engaging or interlocking to provide rotational velocity to the coating material from the tool. In preferred embodiments, the depositing material is continuously or semi-continuously fed and/or delivered into and/or through the throat of the tool. Shearing of any deposited material to form a new surface of the substrate can be performed in a manner to disperse any oxide barrier coating on the substrate. In some embodiments, where welding and/or intense stirring in the surface layer is needed, a pin with a throat can extend from the tool. Depending on the pin profile, diameter and height, the stirred surface layer depth, grain refinement and homogenization can be tightly controlled.

In certain embodiments, the system and associated device can be used in the field of additive friction stir manufacturing. More particularly, deposition of variety of materials, or material and reinforcement particles to workpiece substrates for part fabrication, coating, joining, surface modification, functionalization, repair and formation of in-situ MMC or surface composites by using a friction-based fabrication system and an associated device to perform such processes. The friction-based fabrication system of embodiments of the invention include a machine, a feeding unit, a spindle system, a tool holder and a friction-based fabrication tool.

Examples of friction-based fabrication tools include, but are not limited to, configurations capable of imparting frictional heating, compressive loading, and/or mechanical stirring of the coating material and/or substrate material during processing to allow for the coating material to be applied, adhered, deposited, and/or intermixed with the material of the substrate to form a coating on the substrate. As discussed in detail below, the same or different coatings can provide improved results in the applications in which they are sometimes used.

In certain embodiments, the systems and methods described herein can be used to apply or deposit materials on a substrate by forming a surface layer on a substrate, e.g. by depositing a coating on a substrate using frictional heating and compressive loading of a coating material against the substrate, whereby a tool supports the coating material during frictional heating and compressive loading and is operably configured for forming and shearing a surface of the deposit. Friction-based fabrication tooling for performing such methods can be designed or configured to allow for a consumable coating material to be fed through or otherwise disposed through an internal portion of a non-consumable member, which may be referred to as a throat, neck, center, interior, or through hole disposed through opposing ends of the tool. This region of the tool can be configured with a non-circular through-hole shape. Various interior geometries for the tooling are possible. With a non-circular geometry, the consumable filler material is compelled or caused to rotate at the same angular velocity as the non-consumable portion of the tool due to normal forces being exerted by the tool at the surface of the tool throat against the feedstock. Such geometries include a square through-hole and an elliptical through-hole as examples. In configurations where only tangential forces can be expected to be exerted on the surface of the filler material by the internal surface of the throat of the tool, the feed stock will not be caused to rotate at the same angular velocity as the tool. A circular geometry for the cross-section of the tool in combination with detached or loosely attached feedstock would be expected to result in the deposit material and tool rotating at the same or different velocities.

In certain embodiments, the form of the consumable material can be of any form or shape, such as solid, powder, composite, solid tubes filled with powder, to name a few. For instance, coating material can be deposited on a substrate using a downward frictional force in combination with translational movement across the surface of the substrate at a fixed distance. The filler material is consumed by being forced toward and deposited on the surface of the substrate (which is typically placed on an accessory device or other device as described herein) through the throat of the non-consumable tool using rotation of the tool (and consequently the feed material) and other relative movement between the tool and the substrate such as translational movement. The downward force can be imposed on the filler rod for example by pulling or pushing the material through the throat of the tool. One method is to push the rod with an actuator toward the surface of the substrate. For example, the use of a non-circular through-hole and corresponding shape of filler material may be one example of a way to compel the material in the tool to spin at the same angular velocity as the tool. It has been found that rotational movement of the filler material may be desired for certain applications and that no rotational movement between the filler material and inner geometry of the non-consumable portion of the tool be experienced during use. Further, it the filler material can be operably configured to move freely lengthwise through the tool so as to allow for semi-continuous or continuous feeding of the material toward the substrate for a desired period of time. The associated device which is configured to receive the substrate can be moved independent of movement of the tooling that provides the filler material to permit the production of complex and multi-dimensional shapes.

In certain configurations, the tooling comprises a shearing surface. This surface is used for shearing the surface of the deposit material being deposited to form a new surface of the substrate. The shearing surface can be incorporated in the tool in a variety of ways, including to obtain tooling comprising a collar, spindle, anvil, cylindrical tool, shoulder, equipment, rotating tool, shearing tool, spinning tool, stir tool, tool geometry, or threaded-tapered tool to name a few. The shearing surface is defined more completely by its function, e.g., the surface(s) of the tool capable of trapping, compressing, compacting or otherwise exerting at least a downward (i.e., normal) force on the coating material deposited on the substrate and through the coating material to the substrate.

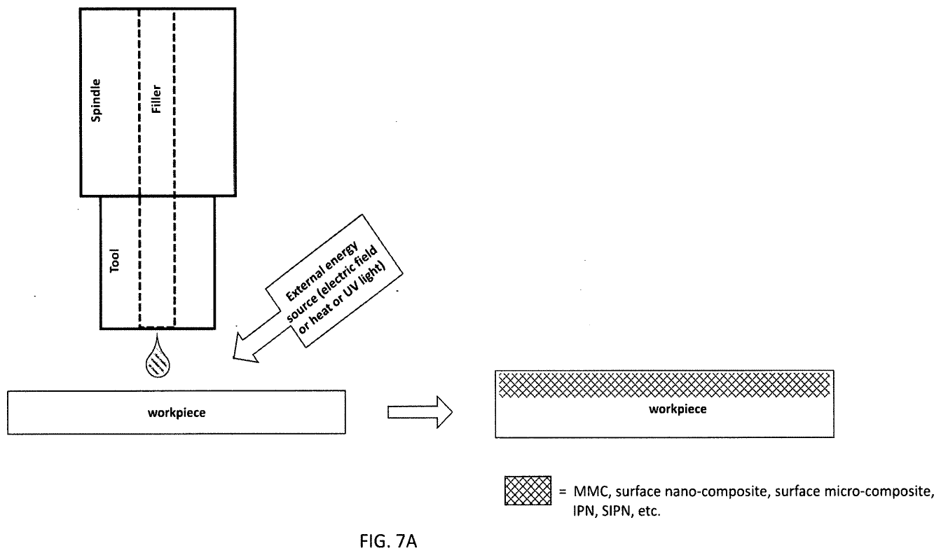

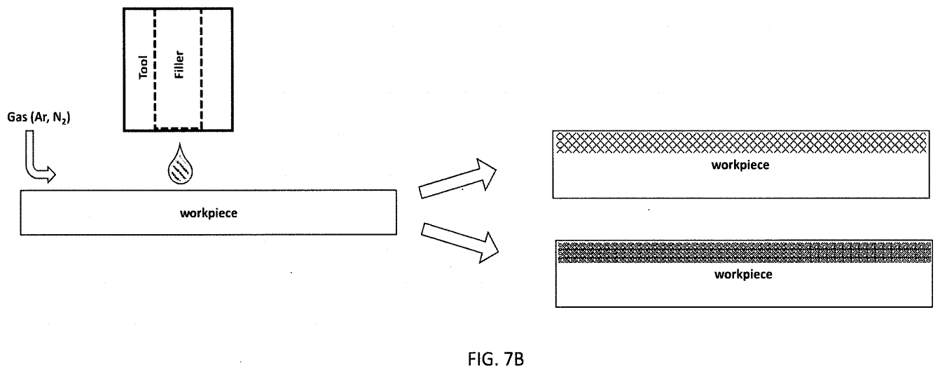

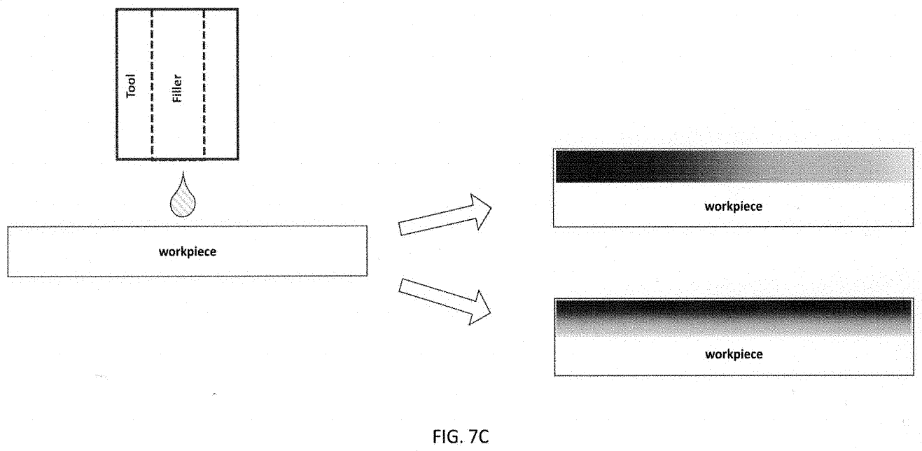

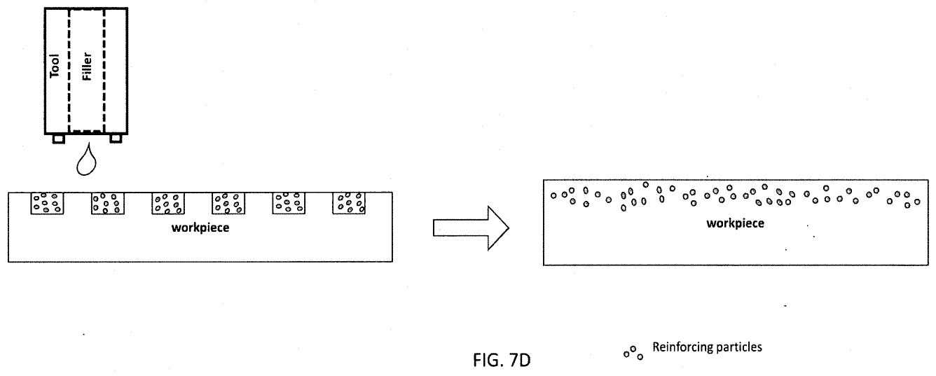

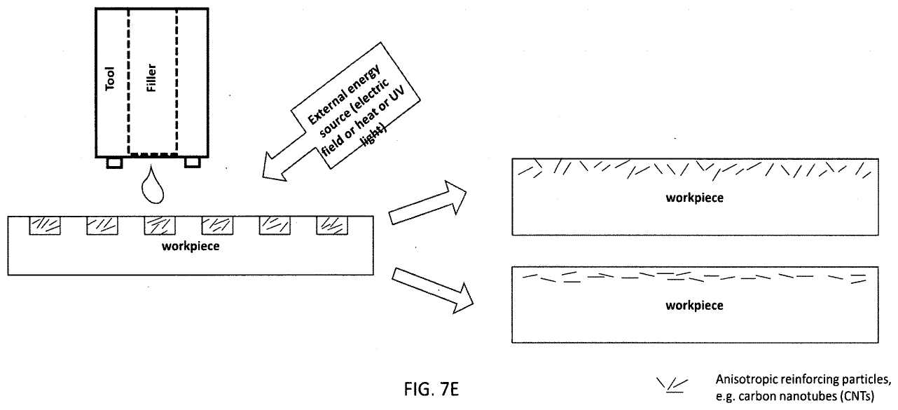

In certain embodiments, the AFS system and any associated device can be used for surface functionalization, surface protection, coating and/or cladding. Deposition of a solid-state coating using filler material on a substrate providing a good chemical (metallurgical) bonding to the substrate can protect it e.g. against wear and corrosion (FIG. 7A). In another embodiment, the AFS system of present invention is used to form surface composites, where the composite layer is well-bonded to the substrate. In yet another embodiment, with the present AFS system's flexibility to accommodate different tool geometries, surface MMC layers are obtained with little or no disintegration of the incorporated ceramic particles.

In another embodiment, metal-polymer composites can be formed by the AFS system. Difficult to mix and bond materials, such as polymers and metals, can be stirred well with the AFS system. Metal/polymer mixtures and/or metal/polymer composites with physical or even chemical bonds are possible with the AFS system. Mechanical dispersion and physical interlocking bonds are possible in friction-stirred plastic-deformed regions.

In another embodiment, the metal-polymer bonding is provided by supplying the prepolymer (or monomer) via the tool throat as a filler material, which upon the intense friction stir and generated friction heating undergoes cross-linking and bonding to the underneath metallic surface (FIG. 7A). In another embodiment, the metallic material is brought in contact and stirred with a prepolymer or a monomer material. During the deposition and the consequent friction stirring, due to both, the friction and the heating, the prepolymer or monomer polymerize and form 3D-network (cross-links) in the affected zone, thus, bonding to the metal.

In yet another embodiment, the prepolymer or a monomer material is subjected to an additional field, e.g. electric field or UV light exposure, and thus, cross-linking (or polymerization) happens in the deposited layers yielding chemically-bonded compositions.

In another embodiment, the AFS system is used to deposit a metal layers on top of a plastic substrate or plastic part, thus providing the mechanical properties' enhancement of the otherwise light weight substrate or part.

In yet another embodiment, the AFS system is used to deposit a polymer coat on a metal substrate or part, and thus, providing a protective, e.g. corrosion-resistant, anti-flammable and/or anti-wear coating.

In other embodiments, inter-penetrating polymer network (IPN) or semi-interpenetrating polymer network (SIPN) coatings can be formed on the surface of the workpiece by the AFS system of the present invention. IPNs and SIPNs are usually elastomeric in nature and useful in e.g. sorption of have metal ions or in species-selective separation processes. Among different approaches for generation of IPN/SIPN are the ones relying on in-situ simultaneous formation of two polymer networks, or the second polymer network is formed in the presence of already existing first polymer network.

In a specific embodiment, the thermoplastic polymer powder or pellets are mixed with monomer or prepolymer of the same or different chemical nature and together are deposited via the tool throat on a workpiece. During the deposition, due to the friction and the generated heat, polymerization (cross-linking) of the monomer (prepolymer) occurs yielding IPN or SIPN on the workpiece surface. In another embodiment, additional heat, UV light or electric field might be added to speed up the cross-linking process.

In another embodiment, two prepolymers (or monomers) are supplied simultaneously via the tool throat and two simultaneous polymerization processes of both monomers occur on the workpiece surface due to the intense friction and generated heat. In another embodiment, additional heat, UV light or electric field might be added to speed up the cross-linking process.

In some embodiments, AFS system is used to join parts made of dissimilar materials, hard to be joined by conventional methods.

In certain embodiments, the AFS system is used for materials densification caused by grain refinement and intense stirring of the surface layers. Such densified layers exhibit improved strength, microhardness and better wear properties.

In yet another embodiment, the AFS system utilizing the inert gas supply and the controlled gas compartment can be used to produce surface deposited layers where the layer composition (i.e. stoichiometry of the final deposited material) has been affected by the blown gas (FIG. 5A). By way of an example only, a Ti or Ti-alloy is used as a filler material added via the throat of the tool to the substrate in a nitrogen-environment yielding TiN surface layer composition, known for its hardness and antibacterial functionality.

Yet in another embodiment, gas is blown over the surface of the workpiece and deposited material, where the gas provides “shielding effect” and protect the materials during the deposition process from e.g. degradation or oxidation (FIG. 7B). For example, a blown gas contributes to the final composition i.e. stoichiometry of the deposited material. The blown gas can generate pores in the deposited surface layer.

In another embodiment, AFS is using gasses to generate certain material structures, such as porous materials and foams, produced with the aid of a gas blown during the AFS process. Open and closed pores are possible and they can be easily controlled by the process parameters.

In another embodiment, surface material layers with reduced density are possible. By blowing a gas during the deposition of the filler material on the substrate, a porous structure can be achieved for applications that still need certain mechanical strength of the base material, but final light-weight parts (7B). By way of an example only, a PVC foam or Al-foam can be formed by blowing gasses during the friction stir of PVC or Al, respectively.

In one embodiment, gradient material composition along the transverse direction of the moving tool of the AFS system is possible (FIG. 7C). By making changes in the content of the filler material, e.g. changing the concentration of the reinforcing particles in the filler, a surface composite with the same or different level of reinforcing particles along the transverse direction is possible.

In another embodiment, gradient material composition along the depth of the deposited layers is possible (FIG. 7C). The capability of the AFS system to do layer by layer deposition coupled with the fact that the feeding system contains several ports to enter the filler materials, reinforcing particles and additives, enables variation in the composition of each of the deposited layers.

In yet another embodiment, gradient micro-/nano-structure along the transverse direction of the moving tool of the AFS system is possible. By making changes in the process parameters during the deposition, as the tool is moving in a transverse direction, the structure of the deposited layer can change.

In some embodiments, gradient micro-/nano-structure along the depth of the deposited layers is possible. The capability of the AFS system to do layer by layer deposition coupled with the fact that the process parameters can vary during the deposition of each of the layers, layers with the same or different and/or gradient micro-structure are possible.

In yet another embodiment, gradient porous structure is possible with the AFS manufacturing system equipped with gas blowing units. By varying the gas blowing rate and other process parameters during the deposition of each layer, a gradient porous structure is possible along the stack of the deposited layers.

In yet another embodiment, gradient functionality is achieved along the deposited material by depositing gradient material composition and/or gradient structure.

In certain embodiments, an anisotropic composition in transverse direction is possible with the AFS system. By supplying, e.g. composite with anisotropic reinforcing particles (CNTs) via the throat of the tool on the substrate, anisotropic deposition coatings are possible. Such coatings can have the same or different properties, such as electrical, magnetic and mechanical properties in the transverse direction compared to the properties in the direction normal to the transverse direction.

In certain embodiments, nano-composite fabrication can be achieved with the AFS system. By example only, a polymer material (PET, PE or other) mixed with nano-clay particles can be introduced through the feeder, mixed together with the aid of heat and high shear causing exfoliation of the clay particles and then deposit the nano-composite on e.g. a plastic substrate.

Such surface nano-composite layer significantly improves the barrier properties of the substrate, useful for e.g. food packaging applications. The introduction of small amounts of exfoliated nano-clay particles into the polymer matrix is one of the passive barrier methods used to improve not only the barrier, but also the thermal stability, and mechanical properties of PET and other polymers widely used in the food- and beverage-packaging industry.

In yet another embodiment, AFS system is used to weld parts of dissimilar materials, where the filler material is added to the weld to enhance the welding strength.

In some embodiments, the surface of the workpiece is drilled with holes or contains pockets or grooves filled with reinforcers (FIGS. 7D and 7E). Passing with the tool having certain nubs' geometry and adding the filler material on the surface of the workpiece provides an intense stirring in the surface zone and making surface composite. In the case with anisotropic reinforcing particles (e.g. CNTs), their preferential orientation is possible via application of external electric or magnetic field. The holes can be filled with material using the systems described herein.

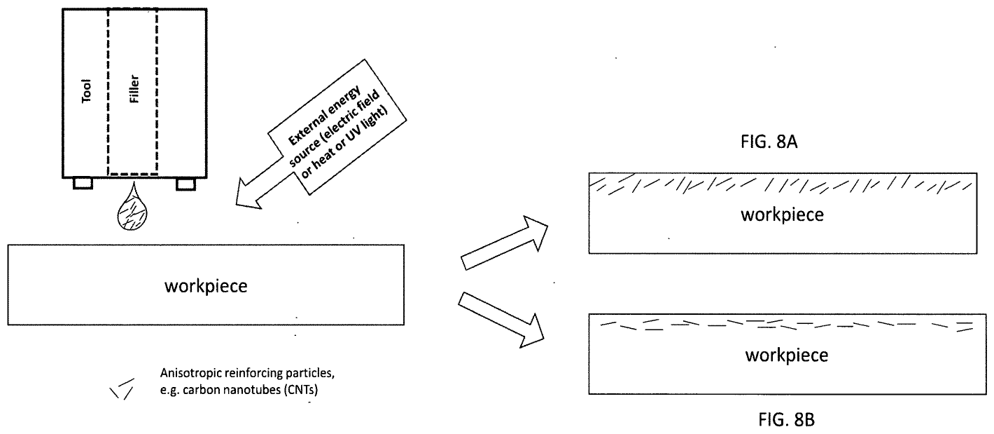

In another embodiment, the reinforcing particles along with the filler material matrix is added on the workpiece surface via the throat of the tool (FIG. 8A).

In yet another embodiment, the anisotropic reinforcing particles, e.g. CNTs, are being added via the tool with throat on the workpiece surface and an external field (electric or magnetic field) applied during the deposition orients the reinforcing particles in a preferred direction (FIG. 8A).

In yet another embodiment only the reinforcing particles are added to the workpiece surface, which are being stirred with the aid of the tool containing nubs within the plasticized workpiece surface material (FIG. 8B).

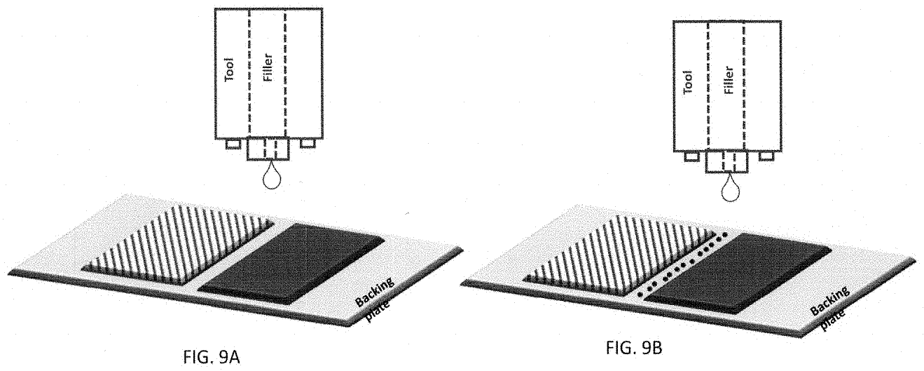

In some embodiments, the AFS system of this invention is used for welding dissimilar materials hard to be welded by other methods. The filler material is added to the weld, between e.g. two plates made of dissimilar materials and it acts as sealant or adhesive (FIG. 9A). A backing plate use is optional.

In other embodiments, the weld between the parts made of two dissimilar materials is filled with the reinforcing particles and the tool of the AFS system of this invention passing through the weld is joining the two parts which weld is being reinforced by the added reinforcers (FIG. 9B). A backing plate use is optional.

In yet another embodiment, AFS system is used to weld parts of dissimilar materials by adding reinforcing fibers, by example only the fibers being carbon fibers or CNTs, in the weld to enhance the welding strength (FIG. 9B). A backing plate use is optional.

The AFS system of the present invention is able to perform various AFS processing methods which disposes the filler material in a localized area or along a predetermined path, or dispose the filler material as a coating over the whole substrate or structure. The versatility of the disclosed AFS system enables to build up, repair, coat or modify the surface of a substrate using frictional heating and compressive loading of the filler material onto substrate.

Build up or formation of 3D structures, such as in situ formation of stiffening ribs, stiffening rings or other reinforcement structures is possible with the system. Also, preformed structures, e.g. ribs can be attached to working piece (substrate) or preformed rings can be attached to tubular workpiece, such as high-pressure vessel.

Repairing defects and damages on flat or curved substrates or defects on parts with tubular configuration is another potential of the AFS system. The system can fill the hole in a substrate by using tiller material and depositing it in the hole and using a backing plate. Also, can repair (fill) a surface crack or propagated crack in any structure.

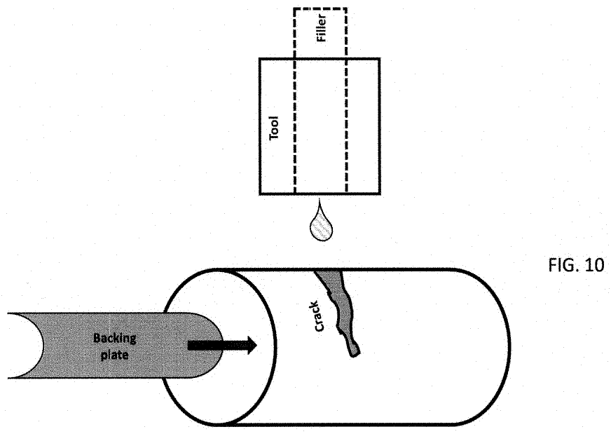

In some embodiments, the AFS system is used to repair a defect or a crack in a part, which can be a plate, a tube, a rail, a substrate or any other structure. As example only, a pipe with a surface crack can be locally repaired by inserting a backing plate (FIG. 10). Moreover, the pipe can be overcoated to further strengthen or protected against e.g. wear or corrosion.

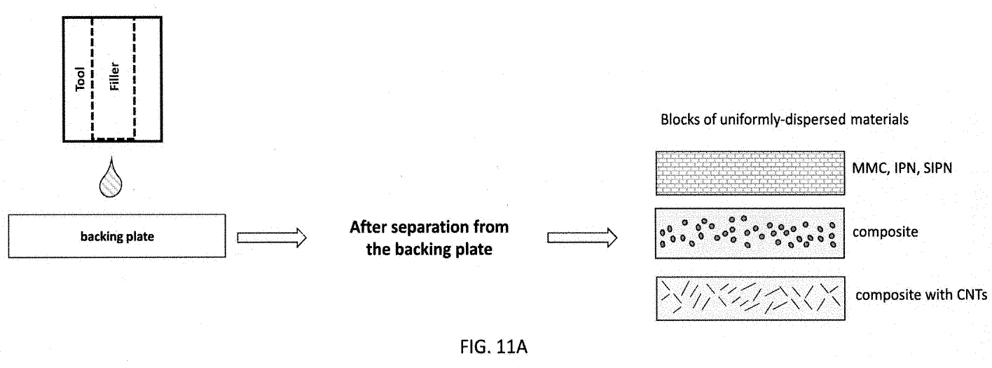

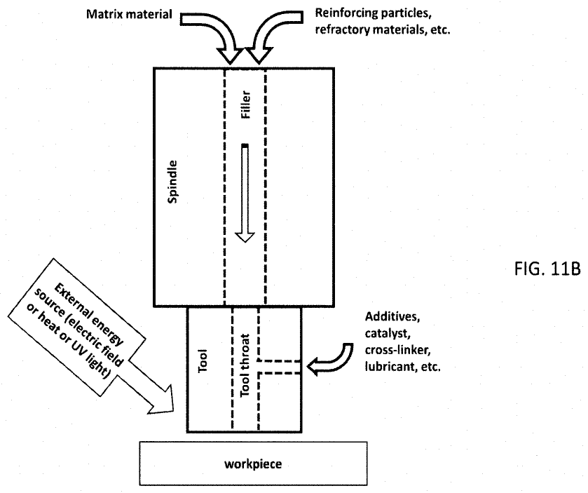

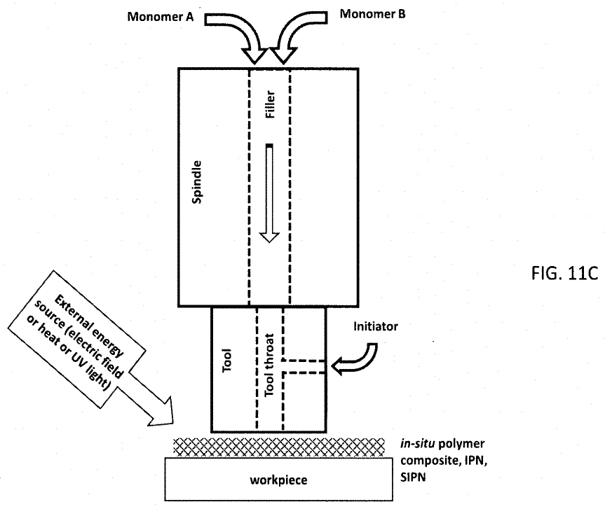

In yet another embodiment, MMC materials of particular composition and micro-/nano-structure are produced as materials blocks to be further used in variety of industries in need for such MMCs (FIG. 11A).

In another embodiment, the weld between the parts made of two dissimilar materials is filled with the liquid monomer. After the AFS tool passing through the weld, due to the friction and the heat, the monomer polymerizes in the weld acting as additional adhesive/sealant to the welded pieces (FIG. 11B).

In another embodiment, the AFS manufacturing system can process high surface energy high aspect ratio particles, such as CNT, that are prone to aggregation and hard to disperse in polymer or other matrices with conventional techniques. The possibility of heating and high shear rate in the feeding unit, coupled with the capability to employ an additional external electric (or magnetic field), enables the particles with high aspect ratio, such as CNTs to disperse and accept preferential orientation.

In yet another embodiment, manufacture of polymer matrices with high loading level of dopants, such as CNTs can be produced. Utilizing the feeding unit of the AFS system accessorized with controllable heating, downward pushing load and rotational speed, as well as the potential of additional external energy source, enables manufacturing of polymers enriched with well-dispersed reinforcement particles (FIG. 11B).

In yet another embodiment, in-situ reaction e.g. polymerization reaction occurs. One or multiple monomers are brought into contact in the feeding unit and as they pass along the throat, the monomers are mixed together. At the last stage, before their deposition on the substrate (or backing plate), the initiator is added and polymerization happens under the intense friction stirring and the associated heat generated by the friction stir. The use of an external energy source (IR heat, UV light, electric field), which can affect polymerization kinetics is optional (FIG. 11C).

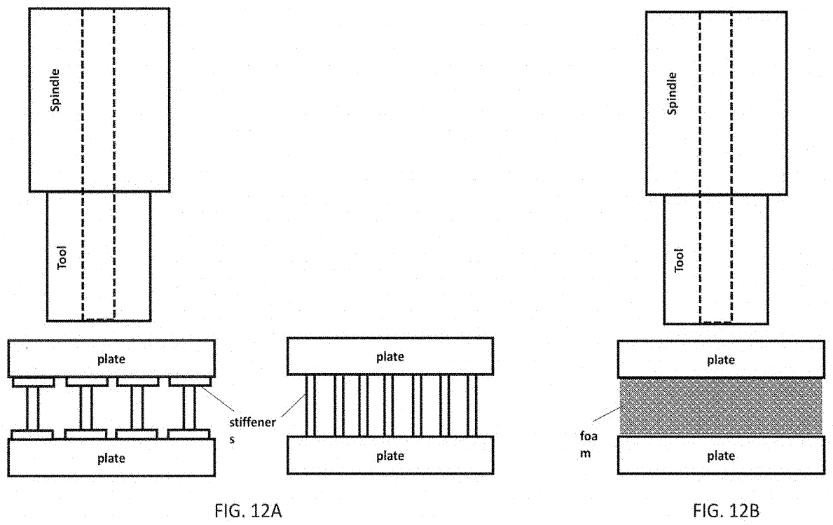

In some embodiments the proposed AFS system is applicable to fabrication of sandwiched structures with improved strength. As presented in FIG. 12A, a stiffened sandwiched structure is made by friction stir process, where the FS tool moves along the surface of one of the plates, and due to frictional stir and associated heating, joins the stiffeners and the second plate into a sandwiched structure. Besides the stiffened construction, such structure can be used as an insulating structure.

In another embodiment, a layer of foam material is placed in the space between two plates is as presented in FIG. 12B. The FS tool is moving along the surface of one of the plates and joins the two plates with the foam interlayer in a compact structure. As examples only, such structure can be used for insulation control or for acoustic control.

Furthermore, the proposed AFS system is suitable for deposition of variety of 3D structures (parts) of numerous materials. By example only, in some embodiments, such parts can be made of conductive materials or insulating materials. The conductive materials used can be intrinsically conductive materials, or can be insulating materials or semiconducting materials doped with conductive particles. In yet other embodiments, the conductive parts can be made to exhibit anisotropic conductivity, i.e. will exhibit enhanced conductivity in a certain direction, while the conductivity in the other two directions is much lower. This is possible by using conductive dopants with high aspect ratio in the insulating or semi-conductive filler materials and their preferential orientation during the deposition and stirring process.

In another embodiment, the parts formed by the AFS system exhibit gradient conductivity within the deposited layers or along the translational deposition direction.

In some embodiments, the parts formed by the AFS system with 3D deposition exhibit anisotropic mechanical properties achieved by depositing e.g. a filler material doped with anisotropic particles with high mechanical properties. By preferential deposition of such filler material and/or application of external energy source, preferential orientation of the dopant particles is possible yielding parts with anisotropic mechanical properties.

In some embodiments, the AFS deposition process can be used alone to manufacture variety of parts and/or cause surface modification, functionalization or coating on the workpiece.

In other embodiments, the AFS deposition process can be used in combination with other manufacturing processes as the final step or staring step or as an intermediate step. As example only, a plastic part is produced by a different process, e.g. by injection molding, and then, subjected to the AFS process for coating the part with e.g. a conductive coating, or simply causing a surface modification of the plastic part.

In certain examples, the MELD® system and the devices used with the MELD system may comprise or use a processor, which can be part of the system or instrument or present in an associated device, e.g., computer, laptop, mobile device, etc. used with the system or device. In one configuration, the processor can be present in a MELD® system and used along with application software to control various aspects of the process and any devices used in the process. Such processes may be performed automatically by the processor without the need for user intervention or a user may enter parameters through a user interface, application software or other methods and devices. For example, the processor can control the rate, direction, angle, etc. of movement of the device and substrate to control the shape of the final part. In certain configurations, the processor may be present in one or more computer systems and/or common hardware circuitry including, for example, a microprocessor and/or suitable software for operating the system, e.g., to control the tooling, the device configured to receive a substrate and any other devices used in the printing process. In some configurations, the device itself may comprise its own respective processor, operating system and other features to permit independent control of the device separate from any MELD® system. The processor can be integral to the systems or may be present on one or more accessory boards, printed circuit boards or computers electrically coupled to the components of the system. The processor is typically electrically coupled to one or more memory units to receive data from the other components of the system and permit adjustment of the various system parameters as needed or desired. The processor may be part of a general-purpose computer such as those based on Unix, Intel PENTIUM-type processor, Intel Core™ processors, Intel Xeon™ processsors, AMD Ryzen™ processors, AMD Athlon™ processors, AMD FX™ processors, Motorola PowerPC, Sun UltraSPARC, Hewlett-Packard PA-RISC processors, Apple-designed processors including Apple A12 processor, Apple Al 1 processor and others or any other type of processor. One or more of any type computer system may be used according to various embodiments of the technology. Further, the system may be connected to a single computer or may be distributed among a plurality of computers attached by a communications network. It should be appreciated that other functions, including network communication, can be performed and the technology is not limited to having any particular function or set of functions. Various aspects may be implemented as specialized software executing in a general-purpose computer system. The computer system may include a processor connected to one or more memory devices, such as a disk drive, memory, or other device for storing data. Memory is typically used for storing programs, printing parameters, and other process conditions and/or devices used in the additive/substrative process. Components of the computer system may be coupled by an interconnection device, which may include one or more buses (e.g., between components that are integrated within a same machine) and/or a network (e.g., between components that reside on separate discrete machines). The interconnection device provides for communications (e.g., signals, data, instructions) to be exchanged between components of the system. The computer system typically can receive and/or issue commands within a processing time, e.g., a few milliseconds, a few microseconds or less, to permit rapid control of the system or device. For example, computer control can be implemented to control printing speed, tooling parameters, device angle or position, etc. The processor typically is electrically coupled to a power source which can, for example, be a direct current source, an alternating current source, a battery, a fuel cell or other power sources or combinations of power sources. The power source can be shared by the other components of the system. The system may also include one or more input devices, for example, a keyboard, mouse, trackball, microphone, touch screen, manual switch (e.g., override switch) and one or more output devices, for example, a display screen, speaker. In addition, the system may contain one or more communication interfaces that connect the computer system to a communication network (in addition or as an alternative to the interconnection device). The system may also include suitable circuitry to convert signals received from the various electrical devices present in the systems. Such circuitry can be present on a printed circuit board or may be present on a separate board or device that is electrically coupled to the printed circuit board through a suitable interface, e.g., a serial ATA interface, ISA interface, PCI interface, a USB interface, a Fibre Channel interface, a Firewire interface, a M.2 connector interface, a PCIE interface, a mSATA interface or the like or through one or more wireless interfaces, e.g., Bluetooth, Wi-Fi, Near Field Communication or other wireless protocols and/or interfaces. If desired, the device used to enable printing of large parts may comprise its own separate printed circuit board that can interface or electrically couple to the MELD® system.

In certain embodiments, the storage system used in the systems described herein typically includes a computer readable and writeable nonvolatile recording medium in which codes of software can be stored that can be used by a program to be executed by the processor or information stored on or in the medium to be processed by the program. The medium may, for example, be a hard disk, solid state drive or flash memory. The program or instructions to be executed by the processor may be located locally or remotely and can be retrieved by the processor by way of an interconnection mechanism, a communication network or other means as desired. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). It may be located in the storage system or in the memory system. The processor generally manipulates the data within the integrated circuit memory and then copies the data to the medium after processing is completed. A variety of mechanisms are known for managing data movement between the medium and the integrated circuit memory element and the technology is not limited thereto. The technology is also not limited to a particular memory system or storage system. In certain embodiments, the system may also include specially-programmed, special-purpose hardware, for example, an application-specific integrated circuit (ASIC), microprocessor units MPU). Aspects of the technology may be implemented in software, hardware or firmware, or any combination thereof. Further, such methods, acts, systems, system elements and components thereof may be implemented as part of the systems described above or as an independent component. Although specific systems are described by way of example as one type of system upon which various aspects of the technology may be practiced, it should be appreciated that aspects are not limited to being implemented on the described system. Various aspects may be practiced on one or more systems having a different architecture or components. The system may comprise a general-purpose computer system that is programmable using a high-level computer programming language. The systems may be also implemented using specially programmed, special purpose hardware. In the systems, the processor is typically a commercially available processor such as the well-known microprocessors available from Intel, AMD, Apple and others. Many other processors are also commercially available. Such a processor usually executes an operating system which may be, for example, the Windows 7, Windows 8 or Windows 10 operating systems available from the Microsoft Corporation, MAC OS X, e.g., Snow Leopard, Lion, Mountain Lion, Mojave, High Sierra, El Capitan or other versions available from Apple, the Solaris operating system available from Sun Microsystems, or UNIX or Linux operating systems available from various sources. Many other operating systems may be used, and in certain embodiments a simple set of commands or instructions may function as the operating system.

In certain examples, the processor and operating system may together define a platform for which application programs in high-level programming languages may be written. It should be understood that the technology is not limited to a particular system platform, processor, operating system, or network. Also, it should be apparent to those skilled in the art, given the benefit of this disclosure, that the present technology is not limited to a specific programming language or computer system. Further, it should be appreciated that other appropriate programming languages and other appropriate systems could also be used. In certain examples, the hardware or software can be configured to implement cognitive architecture, neural networks or other suitable implementations. If desired, one or more portions of the computer system may be distributed across one or more computer systems coupled to a communications network. These computer systems also may be general-purpose computer systems. For example, various aspects may be distributed among one or more computer systems configured to provide a service (e.g., servers) to one or more client computers, or to perform an overall task as part of a distributed system. For example, various aspects may be performed on a client-server or multi-tier system that includes components distributed among one or more server systems; that perform various functions according to various embodiments. These components may be executable, intermediate (e.g., IL) or interpreted (e.g., Java) code which communicate over a communication network (e.g., the Internet) using a communication protocol (e.g., TCP/IP). It should also be appreciated that the technology is not limited to executing on any particular system or group of systems. Also, it should be appreciated that the technology is not limited to any particular distributed architecture, network, or communication protocol.

In some instances, various embodiments may be programmed using an object-oriented programming language, such as, for example, SQL, SmallTalk, Basic, Java, Javascript, PHP, C++, Ada, Python, iOS/Swift, Ruby on Rails or C# (C-Sharp). Other object-oriented programming languages may also be used. Alternatively, functional, scripting, and/or logical programming languages may be used. Various configurations may be implemented in a non-programmed environment (e.g., documents created in HTML, XML or other format that, when viewed in a window of a browser program, render aspects of a graphical-user interface (GUI) or perform other functions). Certain configurations may be implemented as programmed or non-programmed elements, or any combination thereof. In some instances, the systems may comprise a remote interface such as those present on a mobile device, tablet, laptop computer or other portable devices which can communicate through a wired or wireless interface and permit operation of the systems remotely as desired.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1. A solid state additive manufacturing system comprising:
a material feed system;
tooling configured to receive material from the material feed system and print the received material on a substrate;
an accessory device configured to receive the substrate, and
a processor electrically coupled to the tooling and the device, wherein the processor is programmed to control the tooling and to control movement of the device to print the received material onto the received substrate on the device to form a printed part.

2. The solid state additive manufacturing system of claim 1, wherein the accessory device is configured to move and/or rotate the printed part in x-, y- and/or z-direction, or any combination of them.

3. The solid state additive manufacturing system of claim 1, wherein the tooling can move in 3-dimensions to print the material onto the substrate and form the printed part.

4. The solid state additive manufacturing system of claim 1, wherein the accessory device comprises one or more of a robotic arm, a gantry, a moving frame, a crane, a parallel manipulator and combinations thereof.

5. The solid state additive manufacturing system of claim 1, further comprising heating means or cooling means for heating or cooling the substrate, respectively, and/or for heating or cooling the received material or heating or cooling the printed part.

6. The solid state additive manufacturing system of claim 1, further comprising a stimulating device configured to provide an additional field, an electric field, a magnetic field, vibration, ultrasound or light, or any combination of them, to control the microstructure and the mechanical strength of printed part.

7. The solid state additive manufacturing system of claim 1, wherein the accessory device is configured to permit printing of non-hollow (solid), partially-hollow or completely hollow parts, or any combination of them.

8. The solid state additive manufacturing system of claim 1, wherein the accessory device is configured to permit printing of different large shapes, such as cylindrical, rectangular, square-like, oval, hexagonal, octagonal, and others.

9. The solid state additive manufacturing system of claim 1, wherein the accessory device is configured to permit printing of tapered parts, e.g. tapered cylinders, tapered pyramids, etc.

10. The solid state additive manufacturing system of claim 1, wherein the accessory device is configured to permit printing of hollow parts where the part wall thickness changes along one of the axes.

11. The solid state additive manufacturing system of claim 1, wherein the accessory device is configured to permit printing of tilted parts or non-planar parts.

12. An accessory device used in a combination with an additive friction-based fabrication system or a solid state additive manufacturing system, where the device enables manufacturing of large and complex parts, and wherein the device in conjunction with a solid state additive manufacturing system is configured to move and/or rotate the printed part in x-, y- and/or z-direction, or any combination of them.

13. The accessory device of claim 12, wherein the accessory device is configured to enable manufacturing of large parts by any of the following methods: layer-by-layer printing, coating, joining or repairing of existing workpieces, or any combination of them.

14. The accessory device of claim 12, wherein the accessory device is configured to enable adding certain features to pre-fabricated large objects.

15. The accessory device of claim 12, wherein the accessory device comprises one or more robotic arms, gantry, moving frame, crane, parallel manipulator and others to enable the required fabrication and movement of large printed parts.

16. The accessory device of claim 12, wherein the accessory device is configured for use with a 3-axis stationary machine to provide heating and/or cooling during the printing process.

17. The accessory device of claim 12, wherein the accessory device is configured for use with a 3-axis stationary machine to provide additional field, electric field, atmospheric field or magnetic field, vibration, temperature, ultrasound or light, or any combination of them, to control the microstructure and the mechanical strength of printed parts.

18. The accessory device of claim 12, wherein the accessory device is configured for use with the 3-axis stationary machine that comprises various sensors and detectors to monitor, measure and/or control important process parameters, such as temperature, pressure, torque, length or width of printed parts.

19. The accessory device of claim 12, wherein the accessory device is configured to enable fabrication of non-hollow (solid), partially-hollow or completely hollow parts, or any combination of them.

20. The accessory device of claim 12, wherein the accessory device is configured to enable fabrication of different large shapes, such as cylindrical, rectangular, square-like, oval, hexagonal, octagonal, and others.

21-27. (canceled)
